(19) United States
(12) Patent Application Publication
(10) Pub. No.: US 2021/0281947 A1
(43) Pub. Date: Sep. 9, 2021

(54) Speaker Management Device Using Impulse Response

(71) Applicant: JLAB Corporation, Seoul (KR)

(72) Inventor: DAE JIN HAN, Gyeonggi-do (KR)

(73) Assignee: JLAB Corporation, Seoul (KR)

(21) Appl. No.: 17/181,551

(22) Filed: Feb. 22, 2021

(30) Foreign Application Priority Data
Feb. 20, 2020 (KR) 10-2020-0021139
Jun. 16, 2020 (KR) 10-2020-0072672

(51) Int. Cl. H04R 3/12; G06F 3/16

(52) U.S. Cl. CPC H04R 3/12; H04R 2430/01; G06F 3/165

(57) ABSTRACT

Disclosed is a speaker management device including: a user input unit receiving at least one of a first input for selecting a sound output device from a user, a second input for processing an audio signal, and a third input for receiving an output terminal to which a processed audio signal is distributed based on the second input; an input unit receiving a first audio signal from an external source; a storage unit storing at least one of impulse response filters related to each of at least one of different types of sound output devices; an impulse response filter application unit outputting a second audio signal by applying a first impulse response filter related to the first input among the at least one of impulse response filters stored in the storage unit to the first audio signal; an input stage sound processing unit outputting a third audio signal obtained by processing the second audio signal based on the second input; and a router distributing the third audio signal to at least one output terminal related to the third input.

### CROSS-REFERENCE TO RELATED APPLICATIONS

This application claims priority to and the benefit of Korean Patent Application No. 10-2020-0021139 filed in the Korean Intellectual Property Office on Feb. 20, 2020, the entire contents of which are incorporated herein by reference.

### TECHNICAL FIELD

The present disclosure relates to a speaker management device, and particularly, to a speaker management device using an impulse response.

### BACKGROUND ART

A speaker management device is a device that is generally installed in a concert hall and outputs an audio signal inputted from a microphone or sound device through an amplifier or speaker.

Such a speaker management device may amplify an audio signal inputted through an input channel, adjust a tone, or adjust a volume and output the corresponding audio signal through the amplifier or speaker.

On the other hand, singers who use the sound devices the most want to transmit their music to listeners more appealingly or delightfully, sometimes in a good mood. To this end, each singer prefers a branded sound device that suits his/her own voice or his/her playing style. If a concert hall is not equipped with an audio device of a favorite brand, the singers do not hold a concert or may rent an audio device which the singers want from other places. Thus, from the standpoint of a concert hall or a company inviting singers, it was inevitable to incur a lot of cost to have a variety of sound devices.

Therefore, it is necessary to develop a speaker management device for solving the problem.

### SUMMARY OF THE INVENTION

The present disclosure has been made in an effort to provide a speaker management device capable of changing sound output characteristics.

However, technical objects of the present disclosure are not restricted to the technical object mentioned as above. Other unmentioned technical objects will be apparently appreciated by those skilled in the art by referencing to the following description.

An exemplary embodiment of the present disclosure provides a speaker management device. The speaker management device may include: a user input unit receiving at least one of a first input for selecting a sound output device from a user, a second input for processing an audio signal, and a third input for receiving an output terminal to which a processed audio signal is distributed based on the second input; an input unit receiving a first audio signal from an external source; a storage unit storing at least one of impulse response filters related to each of at least one of different types of sound output devices; an impulse response filter application unit outputting a second audio signal by applying a first impulse response filter related to the first input among the at least one of impulse response filters stored in the storage unit to the first audio signal; an input stage sound processing unit outputting a third audio signal by processing the second audio signal based on the second input; and a router distributing the third audio signal to at least one output terminal related to the third input.

The impulse response filter application unit may be located between the input unit and the input stage sound processing unit.

The input stage sound processing unit may perform at least one of a function of adjusting a volume of the second audio signal based on the second input, a function of adjusting a phase of the second audio signal based on the second input, a function of adjusting delay of the second audio signal based on the second input, a function of correcting response characteristic for each frequency band of the second audio signal based on the second input, and a function of removing noise of the second audio signal based on the second input.

The first impulse response filter may be a filter generated by using a measurement sound signal and an output sound signal outputted from a specific sound output device when the measurement sound signal is inputted to the specific sound output device related to the first input.

The speaker management device may further include: at least one output stage sound processing unit connected to each of the at least one output terminal and processing at least one fourth audio signal outputted from the at least one output terminal based on a fourth input inputted through the user input unit; and at least one output unit connected to each of the at least one output stage sound processing unit and transmitting an audio signal outputted from the each of the at least one output stage sound processing unit to each of at least one final sound output device.

The each of the at least one output stage sound processing unit may perform at least one of a function of adjusting a volume of the fourth audio signal based on the fourth input, a function of adjusting a phase of the fourth audio signal based on the fourth input, a function of adjusting delay of the fourth audio signal based on the fourth input, a function of correcting a response characteristic for each frequency band of the fourth audio signal based on the fourth input, and a function of limiting a specific frequency band of the fourth audio signal based on the fourth input.

A first frequency response of a first sound outputted from each of the at least one final sound output device may correspond to a second frequency response of a second sound outputted when the first audio signal related to the first input is inputted to a specific sound output device.

The at least one of impulse response filters may include a finite impulse response filter or an infinite impulse response filter.

The first input may include first information on a manufacturer of the sound output device and second information on a product name of the sound output device.

The impulse response filter application unit may recognize the first impulse response filter from the at least one of impulse response filters stored in the storage unit based on the first information and the second information.

Another exemplary embodiment of the present disclosure provides a method for speaker management performed by a speaker management device, which may include: receiving at least one of a first input for selecting a sound output device, a second input for processing an audio signal, and a third input for receiving an output terminal to which a processed audio signal is distributed based on the second input from a user through a user input unit; receiving a first audio signal from an external source through an input unit; outputting a second audio signal obtained by applying a first impulse response filter related to the first input among at least one of impulse response filters related to each of at least one of different types of sound output devices stored in the storage unit to the first audio signal through an impulse response filter application unit; outputting a third audio signal obtained by processing the second audio signal through an input stage sound processing unit based on the second input; and distributing the third audio signal to at least one output terminal related to the third input through a router.

The impulse response filter application unit may be located between the input unit and the input stage sound processing unit.

The outputting a third audio signal obtained by processing the second audio signal through an input stage sound processing unit based on the second input may include performing, through the input stage sound processing unit, at least one of a function of adjusting a volume of the second audio signal based on the second input, a function of adjusting a phase of the second audio signal based on the second input, a function of adjusting delay of the second audio signal based on the second input, a function of correcting a response characteristic for each frequency band of the second audio signal based on the second input, and a function of removing noise of the second audio signal based on the second input.

The first impulse response filter may be a filter generated by using a measurement sound signal and an output sound signal outputted from a specific sound output device when the measurement sound signal is input to the specific sound output device related to the first input.

The method may further include: after distributing the third audio signal to the at least one output terminal related to the third input through the router, processing at least one fourth audio signal outputted from the at least one output terminal based on a fourth input inputted through the user input unit using at least one output stage sound processing unit connected to each of the at least one output terminal; and transmitting an audio signal outputted from the each of the at least one output stage sound processing unit to each of at least one final sound output device through at least one output unit connected to each of the at least one output stage sound processing unit.

The processing at least one fourth audio signal outputted from the at least one output terminal based on a fourth input inputted using the user input unit through at least one output stage sound processing unit connected to each of the at least one output terminal may include performing, through the each of the at least one output stage sound processing unit, at least one of a function of adjusting a volume of the fourth audio signal based on the fourth input, a function of adjusting a phase of the fourth audio signal based on the fourth input, a function of adjusting delay of the fourth audio signal based on the fourth input, a function of correcting a response characteristic for each frequency band of the fourth audio signal based on the fourth input, and a function of limiting a specific frequency band of the fourth audio signal based on the fourth input.

A first frequency response of a first sound outputted from each of the final sound output device may correspond to a second frequency response of a second sound outputted when the first audio signal related to the first input is inputted to a specific sound output device.

The at least one of impulse response filters may include a finite impulse response filter or an infinite impulse response filter.

The first input may include first information on a manufacturer of the sound output device and second information on a product name of the sound output device.

The outputting of the second audio signal obtained by applying a first impulse response filter related to the first input among at least one of impulse response filters related to at least one of sound output devices of different types stored in the storage unit to the first audio signal through an impulse response filter application unit may further include recognizing the first impulse response filter from the at least one of impulse response filters stored in the storage unit through the impulse response filter application unit based on the first information and the second information.

Technical solving means which can be obtained in the present disclosure are not limited to the aforementioned solving means and other unmentioned solving means will be clearly understood by those skilled in the art from the following description.

According to some exemplary embodiments of the present disclosure, it is possible to provide a speaker management device capable of providing sound output characteristics of each of various sound output devices.

Effects which can be obtained in the present disclosure are not limited to the aforementioned effects and other unmentioned effects will be clearly understood by those skilled in the art from the following description.

### BRIEF DESCRIPTION OF THE DRAWINGS

Various aspects are now described with reference to the drawings and like reference numerals are generally used to designate like elements. In the following exemplary embodiments, for the purpose of description, multiple specific detailed matters are presented to provide general understanding of one or more aspects. However, it will be apparent that the aspect(s) can be executed without the specific detailed matters. In other examples, known structures and apparatuses are illustrated in a block diagram form in order to facilitate description of the one or more aspects.

FIG. 1 is a block diagram for describing an example of a speaker management device according to some exemplary embodiments of the present disclosure.

FIG. 2 is a block diagram for describing an example of an input stage sound processing unit according to some exemplary embodiments of the present disclosure.

FIG. 3 is a block diagram for describing an example of an output stage sound processing unit according to some exemplary embodiments of the present disclosure.

FIG. 4 is a flowchart for describing an example of a method for processing a first audio signal by a speaker management device according to some exemplary embodiments of the present disclosure.

FIG. 5 is a flowchart for describing an example of a method for transmitting an audio signal to a final sound output device by a speaker management device according to some exemplary embodiments of the present disclosure.

FIG. 6 is a diagram for describing a method for generating an impulse response filter stored in a storage unit of a speaker management device according to some exemplary embodiments of the present disclosure.

FIG. 7 is a graph for describing an example of an audio signal outputted from a speaker management device according to some exemplary embodiments of the present disclosure.

### DETAILED DESCRIPTION

Various embodiments and/or aspects will be now disclosed with reference to drawings. In the following description, for the purpose of a description, multiple detailed matters will be disclosed in order to help comprehensive appreciation of one or more aspects. However, those skilled in the art of the present disclosure will recognize that the aspect(s) can be executed without the detailed matters. In the following disclosure and the accompanying drawings, specific exemplary aspects of one or more aspects will be described in detail. However, the aspects are exemplary and some of various methods in principles of various aspects may be used and the descriptions are intended to include all of the aspects and equivalents thereof. Specifically, in “embodiment”, “example”, “aspect”, “illustration”, and the like used in the specification, it may not be construed that a predetermined aspect or design which is described is more excellent or advantageous than other aspects or designs.

Hereinafter, like reference numerals refer to like or similar elements regardless of reference numerals and a duplicated description thereof will be omitted. Further, in describing an embodiment disclosed in the present disclosure, a detailed description of related known technologies will be omitted if it is determined that the detailed description makes the gist of the embodiment of the present disclosure unclear. Further, the accompanying drawings are only for easily understanding the exemplary embodiment disclosed in this specification and the technical spirit disclosed by this specification is not limited by the accompanying drawings.

Although the terms “first”, “second”, and the like are used for describing various elements or components, these elements or components are not confined by these terms, of course. These terms are merely used for distinguishing one element or component from another element or component. Therefore, a first element or component to be mentioned below may be a second element or component in a technical spirit of the present disclosure.

Unless otherwise defined, all terms (including technical and scientific terms) used in the present specification may be used as the meaning which may be commonly understood by the person with ordinary skill in the art, to which the present disclosure pertains. Terms defined in commonly used dictionaries should not be interpreted in an idealized or excessive sense unless expressly and specifically defined.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

The word “comprises” and/or “comprising” means that the corresponding feature and/or component is present, but it should be appreciated that presence or addition of one or more other features, components, and/or a group thereof is not excluded. Further, when not separately specified or it is not clear in terms of the context that a singular form is indicated, it should be construed that the singular form generally means “one or more” in this specification and the claims.

The terms “information” and “data” used in the specification may also be often used to be exchanged with each other.

Suffixes “module” and “unit” for components used in the following description are given or mixed in consideration of easy preparation of the specification only and do not have their own distinguished meanings or roles.

It should be understood that, when it is described that a component is “connected to” or “accesses” another component, the component may be directly connected to or access the other component or a third component may be present therebetween. In contrast, it should be understood that, when it is described that a component is “directly connected to” or “directly access” another component, no component is present between the component and another component.

Suffixes “module” and “unit” for components used in the following description are given or mixed in consideration of easy preparation of the specification only and do not have their own distinguished meanings or roles.

The objects and effects of the present disclosure, and technical constitutions of accomplishing these will become obvious with reference to exemplary embodiments to be described below in detail along with the accompanying drawings. In describing the present disclosure, a detailed description of known function or constitutions will be omitted if it is determined that it unnecessarily makes the gist of the present disclosure unclear. In addition, terms to be described below as terms which are defined in consideration of functions in the present disclosure may vary depending on the intention of a user or an operator or usual practice.

However, the present disclosure is not limited to exemplary embodiments disclosed below but may be implemented in various different forms. However, the exemplary embodiments are provided to make the present disclosure be complete and completely announce the scope of the present disclosure to those skilled in the art to which the present disclosure belongs and the present disclosure is just defined by the scope of the claims. Accordingly, the terms need to be defined based on contents throughout this specification.

In the present disclosure, a speaker management device may apply unique sound characteristics of each of various sound devices (e.g., speakers, amplifiers, etc.) to an input audio signal.

For example, the speaker management device may store a filter using an output sound signal outputted from a specific sound output device. In addition, the speaker management device may apply the filter to a first audio signal inputted from an external source based on an input of a user. That is, specifically, for example, in the speaker management device according to the present disclosure, even when a speaker of company A is connected to an output terminal, a sound similar to a sound of the speaker of company B may be allowed to be outputted from the speaker of company A based on the input of the user.

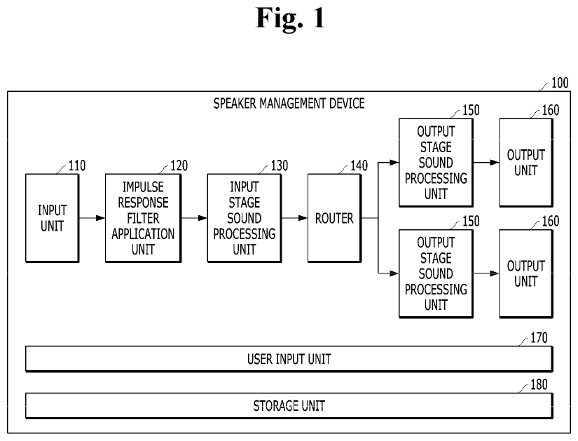

Meanwhile, in the present disclosure, an impulse response filter related to a specific sound output device may be pre-stored. Here, the filter related to the specific sound output device may be a filter generated through an output sound signal output after inputting a measurement sound signal into the specific sound output device, and the measurement sound signal. Specifically, even though the same audio signal is inputted from the same external source into each of a plurality of sound output devices, frequency characteristics of the output audio signal may be different. In addition, the different frequency characteristics may be converted into data through an impulse response. Further, the impulse response converted into the data may be pre-stored as the filter. Hereinafter, contents related to the impulse response are a known technique and a detailed description thereof will be omitted and the speaker management device according to the present disclosure will be described through FIGS. 1 to 7.

FIG. 1 is a block diagram for describing an example of a speaker management device according to some exemplary embodiments of the present disclosure.

Referring to FIG. 1, the speaker management device 100 may include an input unit 110, an impulse response filter application unit 120, an input stage sound processing unit 130, a router 140, a user input unit 170, and a storage unit 180. However, since components described above are not required in implementing the speaker management device 100, the speaker management device 100 may have components more or less than components listed above. Here, respective components may be configured as separate chips, modules, or devices and may be included in one device.

The user input unit 170 may include a mechanical input means (or a mechanical key, for example, a button, a dome switch, a jog wheel, a jog switch, etc.) and a touch input means. However, the present disclosure is not limited thereto.

Meanwhile, in the present disclosure, the user input unit 170 may receive at least one of a first input for selecting the sound output device from the user, a second input for processing the audio signal, and a third input for receiving an output terminal to which the audio signal processed based on the second input is to be distributed.

The first input may be an input for selecting the sound output device.

Specifically, the storage unit 180 of the speaker management device 100 may store information (e.g., information on the manufacturer of the sound output device, information on a product name of the sound output device, etc.) on sound output devices of various manufacturers. In addition, the first input may be an input for selecting the specific sound output device among the sound output devices of various manufacturers. However, the present disclosure is not limited thereto.

More specifically, the first input may include first information on the manufacturer of the sound output device and second information on the product name of the sound output device. Therefore, the speaker management device 100 may recognize a specific product among products which at least one manufacturer has through the first input. However, the present disclosure is not limited thereto.

The second input may be an input for processing the audio signal.

Specifically, the second input may be an input for the user to directly process the audio signal input into the speaker management device 100.

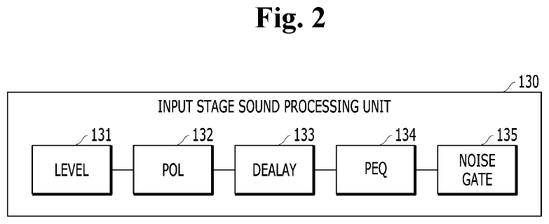

For example, the second input may be an input for adjusting a volume or removing noise of the input audio signal. However, the present disclosure is not limited thereto. Hereinafter, the description of the second input will be described through FIG. 2.

Meanwhile, the third input may be an input for setting an output terminal to which the audio signal processed through the second input is to be distributed. When the output terminal to which the audio signal is to be distributed is set through the third input, the router 140 may distribute the audio signal processed through the second input. For example, the audio signal input into the speaker management device 100 may be outputted from at least one speaker. In this case, the speaker management device 100 may set at least one speaker through which the audio signal is outputted based on the third input.

More specifically, for example, there may be one audio signal inputted into the speaker management device 100. In addition, there may be two speakers connected to the speaker management device 100. In this case, the speaker management device 100 may determine to output the audio signal from both speakers or to output the audio signal from only one speaker based on the third input. However, the present disclosure is not limited thereto.

Meanwhile, the storage unit 180 may include a memory and/or a persistent storage. The memory may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

The storage unit 180 may store information in any form generated or determined by the speaker management device 100 or information inputted from an external device.

Meanwhile, in the present disclosure, the storage unit 180 may store at least one impulse response filter related to each of at least one sound output device of a different type. In addition, at least one sound pulse response filter stored in the storage unit 180 may be loaded by the impulse response filter application unit 120. However, the present disclosure is not limited thereto.

Meanwhile, in the present disclosure, at least one impulse response filter stored in the storage unit 180 may be stored in the storage unit 180 from the time the speaker management device 100 is shipped. However, the present disclosure is not limited thereto, but at least one impulse response filter may be received from an external server or inputted through a mobile storage device.

The input unit 110 may be a microphone or an audio input unit for inputting the audio signal. In addition, the input unit 110 may serve as a passage for various types of external devices connected to the speaker management device 100. The input unit 110 may be a wired/wireless data port, a memory card port, a port connecting a device equipped with an identification module, an audio input port, or the like. However, the present disclosure is not limited thereto.

Meanwhile, in the present disclosure, the input unit 110 may receive a first audio signal from the external source. Here, the external source may be a musical instrument, a microphone, a computing device, or a mobile terminal. However, the present disclosure is not limited thereto.

Meanwhile, according to some exemplary embodiments of the present disclosure, a plurality of input units 110 may be provided. Accordingly, the speaker management device 100 may receive a plurality of first audio signals. However, the present disclosure is not limited thereto.

The impulse response filter application unit 120 may apply an impulse response filter to the first audio signal received from the input unit 110 and output a second audio signal to which the impulse response filter is applied.

Specifically, the impulse response filter application unit 120 may recognize and load a first impulse response filter related to the first input from among at least one impulse response filter stored in the storage unit 180. In addition, the impulse response filter application unit 120 applies the first impulse response filter to the first audio signal to output the corresponding signal as the second audio signal. However, the present disclosure is not limited thereto.

Meanwhile, according to some exemplary embodiments of the present disclosure, the first impulse response filter may be a filter generated by using the measurement sound signal and the output sound signal outputted from the specific sound output device when the measurement sound signal is inputted into the specific sound output device related to the first input. Here, the measurement sound signal may be a test signal. That is, the measurement sound signal may be a signal for measuring output characteristics of the sound outputted from at least one sound device. Therefore, the measurement sound signal may be a signal having the same magnitude in all frequency bands. However, the present disclosure is not limited thereto.

Specifically, in order to generate the first impulse response filter, an external device (e.g., a computing device) may output the measurement sound signal from the specific sound output device related to the first input. In addition, the external device may generate the first impulse response filter by converting the first impulse response of the output sound signal outputted from the specific sound output device. In addition, the speaker management device 100 may store at least one impulse response filter generated through the above description in the storage unit 180. However, the present disclosure is not limited thereto.

Meanwhile, according to some exemplary embodiments of the present disclosure, at least one impulse response filter may be a finite impulse response (FIR) filter or an infinite impulse response (IIR) filter. Here, the finite impulse response filter may be a filter generated by performing filtering with a constant value of the input signal. In addition, the infinite impulse response filter may be a filter generated by performing filtering having a high-order repetition equation by recursively applying a value of an input signal and a value of an output signal. However, the present disclosure is not limited thereto.

Meanwhile, according to some exemplary embodiments of the present disclosure, the impulse response filter application unit 120 may recognize the first impulse response filter among at least one impulse response filter stored in the storage unit 180 based on the first information and the second information. Here, the first information may be information on a manufacturer of the sound output device. In addition, the second information may be information on the product name of the sound output device. Accordingly, when the first input is inputted through the user input unit 170, the impulse response filter application unit 120 may recognize the first impulse response filter. However, the present disclosure is not limited thereto.

Meanwhile, according to some exemplary embodiments of the present disclosure, a plurality of first audio signals may be inputted from the plurality of input units 110. If there is the plurality of input units 110, the number of impulse response filter application units 120 corresponding to the number of input units 110 may be provided. In addition, a first input for each of a plurality of first audio signals inputted from each of the plurality of input units 110 may be required. In this case, each of the plurality of impulse response filter application units 120 may apply each of the plurality of first impulse response filters to each of the plurality of first audio signals based on the first input for each of the plurality of first audio signals. In addition, the plurality of impulse response filter application units 120 may output a plurality of second audio signals acquired by applying a plurality of first impulse response filters to the plurality of first audio signals, respectively. However, the present disclosure is not limited thereto.

Meanwhile, the input stage sound processing unit 130 may output a third audio signal acquired by processing the second audio signal based on the second input.

For example, the input stage sound processing unit 130 may perform at least one of a function of adjusting the volume of the second audio signal based on the second input, a function of adjusting a phase of the second audio signal, a function of adjusting a delay of the second audio signal, a function of removing the noise of the second audio signal, and a function of correcting response characteristics for each frequency band of the second audio signal. In addition, the input stage sound processing unit 130 may output a third audio signal acquired by processing the second audio signal. However, the present disclosure is not limited thereto. Hereinafter, the input stage sound processing unit 130 will be described below through FIG. 2.

Meanwhile, according to some exemplary embodiments of the present disclosure, when there is a plurality of input units 110, input stage sound processing units 130 of a number corresponding to the number of input units 110 may be provided. In addition, the second input for each of the plurality of first audio signals inputted from each of the plurality of input units 110 may be required. In this case, each of the plurality of input stage sound processing units 130 may process each of the plurality of second audio signals into each of the plurality of third audio signals based on the second input for each of the plurality of second audio signals, and output each of the plurality of third audio signals. However, the present disclosure is not limited thereto.

Meanwhile, according to some exemplary embodiments of the present disclosure, the impulse response filter application unit 120 may be located between the input unit 110 and the input stage sound processing unit 130. That is, the speaker management device 100 may first output the second audio signal by applying the first impulse response filter to the first audio signal. In addition, the speaker management device 100 may generate a third audio signal by processing the second audio signal. However, the present disclosure is not limited thereto.

Meanwhile, the router 140 may distribute the third audio signal to at least one output terminal related to the third input. Here, at least one output terminal may be connected to a sound device that finally outputs the audio signal, such as at least one speaker or at least one amplifier. However, the present disclosure is not limited thereto. For example, the router 140 may distribute the third audio signal as at least one fourth audio signal based on the third input and transmit the fourth audio signal to each of at least one output terminal. In this case, each of at least one fourth audio signal may be a signal which is the same as the third audio signal. However, the present disclosure is not limited thereto.

Meanwhile, according to some exemplary embodiments of the present disclosure, when there is a plurality of input units 110, the third input for each of the plurality of first audio signals inputted through each of the plurality of input units 110 may be required. In this case, the router 140 may determine an output terminal to output each of the plurality of third audio signals based on the third input for each of the plurality of first audio signals. However, the present disclosure is not limited thereto.

Meanwhile, according to some exemplary embodiments of the present disclosure, the router 140 may be further provided between the input unit 110 and the plurality of impulse response filter application units 120. In this case, the first audio signal input through the input unit 110 may be distributed through the router 140 and transmitted to the plurality of impulse response filter application units 120. However, the present disclosure is not limited thereto.

Meanwhile, the speaker management device 100 may further include at least one output stage sound processing unit 150 and at least one output unit 160. However, the present disclosure is not limited thereto, and the speaker management device 100 may not include at least one output stage sound processing unit 150 and at least one output unit 160.

At least one output stage sound processing unit 150 may be connected to each of at least one output terminal of the router 140. In addition, at least one output stage sound processing unit 150 may process at least one fourth audio signal outputted from at least one output terminal based on a fourth input inputted through the user input unit 170. However, the present disclosure is not limited thereto.

Here, the fourth input may be an input for directly processing the fourth audio signal by the user.

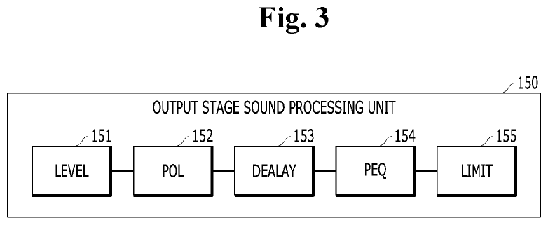

For example, each of at least one output stage sound processing unit 150 may perform at least one of a function of adjusting the volume of the fourth signal, a function of adjusting the phase of the fourth audio signal, a function of adjusting the delay of the fourth audio signal, a function of correcting the response characteristics for each frequency band of the fourth audio signal, and a function of limiting a specific frequency band in the fourth audio signal, based on the fourth input. In addition, each of at least one output stage sound processing unit 150 may output an audio signal acquired by processing the fourth audio signal. However, the present disclosure is not limited thereto. Hereinafter, the fourth input will be described through FIG. 3.

At least one output unit 160 may serve as a passage for various types of external devices connected to the speaker management device 100. The at least one output unit 160 may be a wired/wireless data port, a port connecting a device equipped with an identification module, an audio out (O) port, or the like. However, the present disclosure is not limited thereto.

In the present disclosure, each of at least one output unit 160 may be connected to each of at least one output stage sound processing unit 150. In addition, each of at least one output unit 160 may transmit the audio signal outputted from each of at least one output stage sound processing unit 150 to each of at least one final sound output device. However, the present disclosure is not limited thereto.

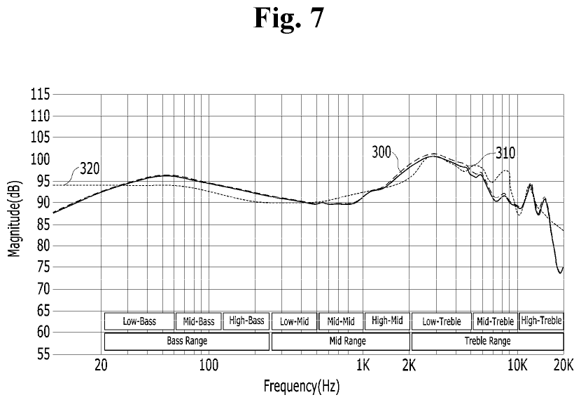

Meanwhile, according to some exemplary embodiments of the present disclosure, a first frequency response of a first sound outputted from each of the final sound output devices may correspond to a second frequency response of a second sound outputted when the first audio signal is inputted into the specific sound output device related to the first input. That is, the first audio signal inputted through the input unit 110 of the speaker management device 100 may be outputted similarly to the audio signal outputted from the specific sound output device. Hereinafter, the related contents will be described later with reference to FIG. 7.

According to the above-described configuration, the speaker management device 100 may process and output the first audio signal inputted through the input unit 110 similarly to the audio signal outputted from a device of a specific manufacturer based on the user input inputted through the user input unit 170. Accordingly, the user may output the audio signal by implementing characteristics of the specific sound output device through the speaker management device 100 even if a plurality of sound output devices is not provided.

Meanwhile, in the present disclosure, the input stage sound processing unit 130 may correct the second audio signal based on the second input inputted through the user input unit 170. Hereinafter, the input stage sound processing unit 130 according to the present disclosure will be described with reference to FIG. 2.

FIG. 2 is a block diagram for describing an example of an input stage sound processing unit according to some exemplary embodiments of the present disclosure.

Referring to FIG. 2, the input stage sound processing unit 130 may include at least one of a LEVEL module 131, a POL module 132, a DELAY module 133, a PEQ module 134, and a NOISE GATE module 135. However, since components described above are not required in implementing the input stage sound processing unit 130, the input stage sound processing unit 130 may thus have components more or less than components listed above. Here, respective components may be configured as separate chips, modules, or devices and may be included in one device. In addition, the positional relationship of the above-described components is only an example for describing the input stage sound processing unit 130, and is not limited to the positions illustrated in the drawings.

The LEVEL module 131 may be a module for adjusting the volume of the second audio signal.

Specifically, the LEVEL module 131 may adjust the volume of the second audio signal based on the second input inputted through the user input unit 170. However, the present disclosure is not limited thereto.

The POL module 132 may adjust the phase of the second audio signal based on the second input inputted through the user input unit 170.

The DELAY module 133 may adjust the delay of the second audio signal based on the second input inputted through the user input unit 170. Here, when the output of the second audio signal is delayed, the DELAY module 133 may be a module that advances or intentionally delays and outputs the second audio signal.

The PEQ module 134 may correct a response characteristic for each frequency band of the second audio signal based on the second input inputted through the user input unit 170.

For example, the PEQ module 134 may correct a frequency characteristic of at least one of a low, mid, and high frequency range included in the second audio signal based on the second input. However, the present disclosure is not limited thereto.

The NOISE GATE module 135 may remove noise from the second audio signal based on the second input inputted through the user input unit 170.

Specifically, the NOISE GATE module 135 may not pass a sound inputted at a level set based on the second input or less. However, the present disclosure is not limited thereto.

According to the above-described configuration, the input stage sound processing unit 130 may provide various functions of processing the second audio signal to which the first impulse response filter is applied. Accordingly, the user may set the audio signal outputted from the final sound output device through the user input unit 170 to be more similar to the sound outputted from the specific sound output device.

Meanwhile, according to some exemplary embodiments of the present disclosure, the third audio signal processed by the input end sound processing unit 130 may be distributed to at least one output end sound processing unit 150 through the router 140. In this case, the speaker management device 100 may process each of at least one distributed fourth audio signal. Hereinafter, the output stage sound processing unit 150 according to the present disclosure will be described through FIG. 3.

FIG. 3 is a block diagram for describing an example of at least one output stage sound processing unit according to some exemplary embodiments of the present disclosure.

Referring to FIG. 3, at least one output stage sound processing unit 150 may include at least one of a LEVEL module 151, a POL module 152, a DELAY module 153, a PEQ module 154, and a LIMIT module 155. However, since components described above are not required in implementing at least one output stage sound processing unit 150, at least one output stage sound processing unit 150 may thus have components more or less than components listed above. Here, respective components may be configured as separate chips, modules, or devices and may be included in one device. In addition, the positional relationship of the above-described components is only an example for describing at least one output stage sound processing unit 150, and is not limited to the positions illustrated in the drawings.

The LEVEL module 151 may be a module for adjusting the volume of at least one fourth audio signal.

Specifically, the LEVEL module 151 may adjust the volume of at least one fourth audio signal based on the fourth input inputted through the user input unit 170. However, the present disclosure is not limited thereto.

The POL module 135 may adjust the phase of at least one fourth audio signal based on the fourth input inputted through the user input unit 170. However, the present disclosure is not limited thereto.

The DELAY module 153 may adjust the delay of at least one fourth audio signal based on the fourth input inputted through the user input unit 170. Here, when the output of at least one four audio signal is delayed, the DELAY module 153 may be a module that advances or intentionally delays and outputs the fourth audio signal. However, the present disclosure is not limited thereto.

The PEQ module 154 may correct a response characteristic for each frequency band of at least one fourth audio signal based on the fourth input inputted through the user input unit 170. However, the present disclosure is not limited thereto.

For example, the PEQ module 154 may correct a frequency characteristic of at least one of a low, mid, and high frequency range included in at least one fourth audio signal based on the fourth input. However, the present disclosure is not limited thereto.

The LIMIT module 155 may limit a specific frequency band in at least one fourth audio signal based on the fourth input inputted through the user input unit 170.

For example, the LIMIT module 155 may limit a specific frequency band or more not to be outputted in at least one fourth audio signal based on the fourth input. However, the present disclosure is not limited thereto.

According to the above-described configuration, at least one output stage sound processing unit 150 may provide various functions of processing at least one fourth audio signal distributed through the router 140. Accordingly, the user may process the audio signal in more detail in consideration of the installation location of the final sound output device. However, the present disclosure is not limited thereto.

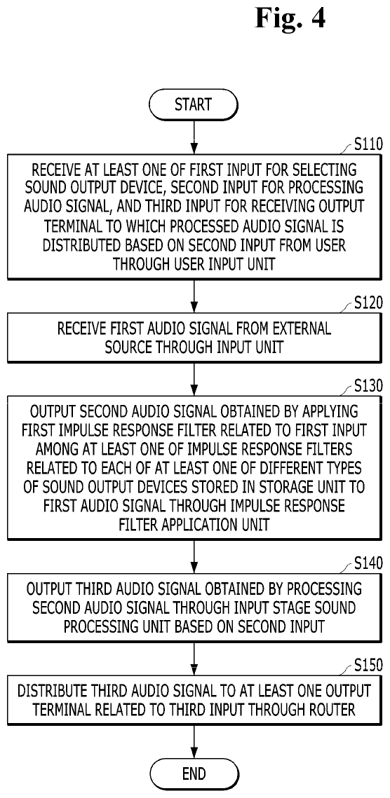

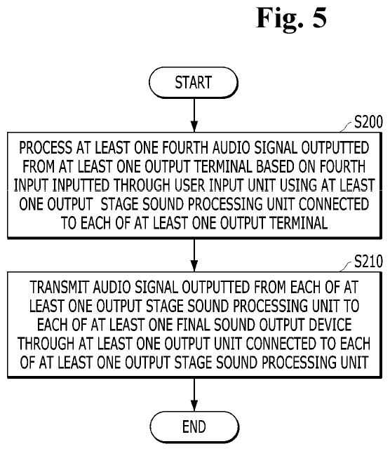

Hereinafter, a method for processing the first audio signal by the speaker management device 100 will be described with reference to FIGS. 4 and 5.

FIG. 4 is a flowchart for describing an example of a method for processing a first audio signal by a speaker management device according to some exemplary embodiments of the present disclosure.

Referring to FIG. 4, the speaker management device 100 may receive at least one of a first input for selecting the sound output equipment from the user, a second input for processing the audio signal, and a third input for receiving an output terminal to which the audio signal processed based on the second input is to be distributed through the user input unit 170 (S110).

Specifically, the speaker management device 100 may receive a first input for inputting at least one product among products of manufacturers of a plurality of sound output devices stored in the storage unit 180 from the user through the user input unit 170. However, the present disclosure is not limited thereto.

In addition, the speaker management device 100 may receive a second input for directly processing the audio signal input from the user through the user input unit 170. However, the present disclosure is not limited thereto.

The speaker management device 100 may receive a third input for selecting an output terminal to which the audio signal processed based on the second input is to be distributed through the user input unit 170.

Meanwhile, the speaker management device 100 may receive the first audio signal from the external source through the input unit 110 (S120).

For example, the speaker management device 100 may receive the first audio signal from a musical instrument, a computing device, a mobile terminal, and other devices. However, the present disclosure is not limited thereto.

Meanwhile, according to some exemplary embodiments of the present disclosure, step S120 of receiving the first audio signal from the external source through the input unit 110 by the speaker management device 100 may be prioritized over step S110. However, the present disclosure is not limited thereto.

Meanwhile, the speaker management device 100 may apply the first impulse response filter related to the first input among at least one impulse response filter related to each of at least one sound output device of different types stored in the storage unit 180 to the first audio signal through the impulse response filter application unit 120, and output the second audio signal (S130).

Specifically, the impulse response filter application unit 120 of the speaker management device 100 may recognize the first impulse response filter among at least one impulse response filter stored in the storage unit 180 based on the first information and the second information included in the first input inputted from the user. In addition, the impulse response filter application unit 120 may apply the first impulse response filter to the first audio signal. However, the present disclosure is not limited thereto.

Meanwhile, the speaker management device 100 may process the second audio signal into a third audio signal through the input stage sound processing unit 130 and output the third audio signal based on the second input (S140).

For example, the input stage sound processing unit 130 may perform at least one of a function of adjusting the volume of the second audio signal based on the second input, a function of adjusting a phase of the second audio signal, a function of adjusting a delay of the second audio signal, a function of removing the noise of the second audio signal, and a function of correcting response characteristics for each frequency band of the second audio signal. In addition, the input stage sound processing unit 130 may output a third audio signal acquired by processing the second audio signal. However, the present disclosure is not limited thereto.

Meanwhile, according to some exemplary embodiments of the present disclosure, the second input inputted through the user input unit 170 may be performed after step S130. However, the present disclosure is not limited thereto.

Meanwhile, the speaker management device 100 may distribute the third audio signal to at least one output terminal related to the third input through the router 140 (S150).

For example, the router 140 may process the third audio signal into at least one fourth audio signal and transmit the fourth audio signal to at least one output terminal. However, the present disclosure is not limited thereto.

Meanwhile, in the present disclosure, at least one fourth audio signal distributed through the router 140 may be reprocessed through at least one output stage sound processing unit 150. Hereinafter, a method for reprocessing and outputting at least one audio signal distributed from the router 140 by the speaker management device 100 according to the present disclosure will be described with reference to FIG. 5.

FIG. 5 is a flowchart for describing an example of a method for transmitting an audio signal to a final sound output device by a speaker management device according to some exemplary embodiments of the present disclosure.

Referring to FIG. 5, after the step of distributing the third audio signal to at least one output terminal related to the third input through the router, the speaker management device 100 may process at least one fourth audio signal outputted from at least one output terminal based on the fourth input inputted through the user input unit 170 by using at least one output stage sound processing unit 150 connected to each of at least one output terminal (S200).

For example, each of at least one output stage sound processing unit 150 may perform at least one of a function of adjusting the volume of the fourth audio signal, a function of adjusting the phase of the fourth audio signal, a function of adjusting the delay of the fourth audio signal, a function of correcting the response characteristics for each frequency band of the fourth audio signal, and a function of limiting a specific frequency band in the fourth audio signal, based on the fourth input. In addition, each of at least one output stage sound processing unit 150 may output an audio signal acquired by processing the fourth audio signal. However, the present disclosure is not limited thereto.

Meanwhile, the speaker management device 100 may transmit the audio signal outputted from each of at least one output stage sound processing unit 150 to each of at least one final sound output device through at least one output unit 160 connected to each of at least one output stage sound processing unit 150 (S210).

In this case, the at least one output unit 160 may be an audio output port, etc. Accordingly, the speaker management device 100 may output at least one final processed audio signal through each of at least one final output device connected to each of the at least one output unit 160. However, the present disclosure is not limited thereto.

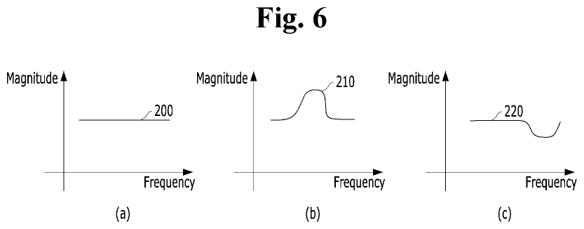

On the other hand, the speaker management device 100 according to the present disclosure may output the audio signal inputted through the input unit 110 similarly to characteristics (e.g., frequency response) of an output sound outputted from a specific sound output device by using at least one impulse response filter. To this end, the speaker management device 100 may be provided without specific characteristics. That is, when the audio signal inputted into the speaker management device 100 is transmitted to the final sound output device without any processing, the characteristic (e.g., frequency response) of the output audio signal outputted from the final sound output device may be flat. Hereinafter, a method for generating the impulse response filter stored in the storage unit 180 of the speaker management device 100 will be described in more detail with reference to FIG. 6.

FIG. 6 is a diagram for describing a method for generating an impulse response filter stored in a storage unit of a speaker management device according to some exemplary embodiments of the present disclosure. The x axis of the graph shown in FIG. 6 may indicate the frequency of the audio signal, and the y axis may indicate the magnitude of the audio signal in each frequency band. In addition, the graph shown in FIG. 6 is a graph related to the frequency response of the audio signal.

FIG. 6A is a graph related to the frequency response of the measurement sound signal. Referring to FIG. 6A, the measurement sound signal may be a sound signal having the same magnitude in all frequency bands.

The graph shown in FIG. 6B is a graph showing the frequency response of the output sound signal outputted from the specific sound output device when the measurement sound signal shown in FIG. 6A is input into the specific sound output device. In addition, the graph shown in FIG. 6C is a graph showing, when the measurement sound signal shown in FIG. 6A is inputted into a sound output device different from the specific sound output device used in FIG. 6B, the frequency response of the output sound signal outputted from the corresponding sound output device.

Referring to FIGS. 6B and 6C, when the same measurement sound signal is inputted into different sound output devices, audio signals having different frequency responses may be outputted from respective sound output devices.

The speaker management device 100 of the present disclosure may store, in the storage unit 180, an impulse response filter generated by using the output sound signal outputted after inputting the same measurement sound signal into each of various different sound output devices (e.g., speaker) by models manufactured by various manufacturers, and the measurement sound signal. That is, the impulse response filter for each of the sound output devices of various models manufactured by various manufacturers may be stored in the storage unit 180. Therefore, even though a sound output device desired by the user is not connected to the speaker management device 100, the speaker management device 100 may allow an audio signal having a frequency characteristic desired by the user to be outputted from another sound output device.

FIG. 7 is a graph for describing an example of an audio signal output from a speaker management device according to some exemplary embodiments of the present disclosure. The x axis of the graph shown in FIG. 7 may indicate the frequency of the audio signal, and the y axis may indicate the magnitude of the audio signal in each frequency band. In addition, the graph shown in FIG. 7 is a graph related to the frequency response of the audio signal.

A first line 300 of FIG. 7 may be a line showing a frequency response of an output audio signal outputted from a specific sound output device when the first audio signal is inputted into the specific sound output device. That is, the first line 300 may be a line showing the frequency characteristic desired by the user.

A second line 310 may be a line showing the frequency response of the output audio signal outputted from the final sound output device when the first audio signal is inputted into the speaker management device 100 and not subjected to any processing. That is, when the user inputs nothing into the speaker management device 100, the frequency characteristic of the audio signal outputted from the final sound output device may be different from the frequency characteristic outputted from the specific sound output device. The reason is that the final sound output device has a different speaker characteristic from the specific sound output device.

Meanwhile, a third line 320 may be a line showing the frequency response of the output audio signal outputted from the final sound output device connected to at least one output unit 160 when an audio signal processed after the first audio signal inputted into the speaker management device 100 through the input unit 110 is primarily processed through the impulse response filter selected based on the first input inputted from the user through the user input unit 170 is minutely processed based on the second input. That is, the speaker management device 100 may allow the audio signal outputted from the final sound output device to have the same frequency characteristic as the third line 320 which is the same as or similar to the first line 300 targeted by the user. Here, in the case of not primarily processing the audio signal inputted by using the impulse response filter, the user who uses the speaker management device 100 should directly process the input audio signal as a whole, so high expertise is required from the user. However, according to the speaker management device 100 of the present disclosure, after the user selects his or her desired specific sound output device, only the audio signal that is primarily processed using the impulse response filter selected according to the user's input is finely adjusted, thereby providing convenience to the user. In addition, when the speaker management device 100 of the present disclosure is used, high expertise may not be required from the user.

According to FIGS. 1 to 7 described above, the user may allow the sound outputted from the final sound output device connected to the speaker management device 100 to be similar to the sound outputted from the specific sound output device desired thereby by using the speaker management device 100 of the present disclosure. In this case, high expertise may not be required from the user.

The description of the presented embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the embodiments presented herein, but should be interpreted within the widest range which is coherent with the principles and new features presented herein.

What is claimed is:

1. A speaker management device comprising:
a user input unit receiving a first input for selecting a sound output device from a user, a second input for processing an audio signal, and a third input for receiving an output terminal to which a processed audio signal is distributed based on the second input;
an input unit receiving a first audio signal from an external source;
a storage unit storing a plurality of impulse response filters related to each of a plurality of different types of sound output devices;
an impulse response filter application unit outputting a second audio signal by applying a first impulse response filter related to the first input among the plurality of impulse response filters stored in the storage unit to the first audio signal;
an input stage sound processing unit outputting a third audio signal by processing the second audio signal based on the second input; and
a router distributing the third audio signal to at least one output terminal related to the third input;
wherein the first input includes first information on a manufacturer of the sound output device and second information on a product name of the sound output device.

2. The speaker management device of claim 1, wherein the impulse response filter application unit is located between the input unit and the input stage sound processing unit.

3. The speaker management device of claim 1, wherein the input stage sound processing unit performs at least one of a function of adjusting a volume of the second audio signal based on the second input, a function of adjusting phase of the second audio signal based on the second input, a function of adjusting delay of the second audio signal based on the second input, a function of correcting response characteristic for each frequency band of the second audio signal based on the second input, and a function of removing noise of the second audio signal based on the second input.

4. The speaker management device of claim 1, wherein the first impulse response filter is a filter generated by using a measurement sound signal and an output sound signal outputted from a specific sound output device when the measurement sound signal is input to the specific sound output device related to the first input.

5. The speaker management device of claim 1, wherein the speaker management device further comprises:
at least one output stage sound processing unit connected to each of the at least one output terminal and processing at least one fourth audio signal outputted from the at least one output terminal based on a fourth input inputted through the user input unit; and
at least one output unit connected to each of the at least one output stage sound processing unit and transmitting an audio signal outputted from the each of the at least one output stage sound processing unit to each of at least one final sound output device.

6. The speaker management device of claim 5, wherein the each of the at least one output stage sound processing unit performs at least one of a function of adjusting a volume of the fourth audio signal based on the fourth input, a function of adjusting phase of the fourth audio signal based on the fourth input, a function of adjusting delay of the fourth audio signal based on the fourth input, a function of correcting response characteristic for each frequency band of the fourth audio signal based on the fourth input, and a function of limiting specific frequency band of the fourth audio signal based on the fourth input.

7. The speaker management device of claim 5, wherein a first frequency response of a first sound outputted from each of the at least one final sound output device corresponds to a second frequency response of a second sound outputted when the first audio signal related to the first input is inputted to a specific sound output device.

8. The speaker management device of claim 1, wherein the plurality of impulse response filters include a finite impulse response filter or an infinite impulse response filter.

9. The speaker management device of claim 1, wherein the impulse response filter application unit recognizes the first impulse response filter from the plurality of impulse response filters stored in the storage unit based on the first information and the second information.

10. A method for speaker management performed by a speaker management device comprising:
receiving a first input for selecting a sound output device, a second input for processing an audio signal, and a third input for receiving an output terminal to which a processed audio signal is distributed based on the second input from a user through a user input unit;
receiving a first audio signal from an external source through an input unit;
outputting a second audio signal obtained by applying a first impulse response filter related to the first input among a plurality of impulse response filters stored in the storage unit to the first audio signal through an impulse response filter application unit, wherein the plurality of impulse response filters are related to each of a plurality of different types of sound output devices;
outputting a third audio signal obtained by processing the second audio signal through an input stage sound processing unit based on the second input; and
distributing the third audio signal to at least one output terminal related to the third input through a router;
wherein the first input includes first information on a manufacturer of the sound output device and second information on a product name of the sound output device.

11. The method for speaker management of claim 10, wherein the impulse response filter application unit is located between the input unit and the input stage sound processing unit.

12. The method for speaker management of claim 10, wherein the outputting a third audio signal obtained by processing the second audio signal through an input stage sound processing unit based on the second input comprises:
performing, through the input stage sound processing unit, at least one of a function of adjusting a volume of the second audio signal based on the second input, a function of adjusting phase of the second audio signal based on the second input, a function of adjusting delay of the second audio signal based on the second input, a function of correcting response characteristic for each frequency band of the second audio signal based on the second input, and a function of removing noise of the second audio signal based on the second input.

13. The method for speaker management of claim 10, wherein the first impulse response filter is a filter generated by using a measurement sound signal and an output sound signal outputted from a specific sound output device when the measurement sound signal is inputted to the specific sound output device related to the first input.

14. The method for speaker management of claim 10, after distributing the third audio signal to the at least one output terminal related to the third input through the router, processing at least one fourth audio signal outputted from the at least one output terminal based on a fourth input inputted through the user input unit using at least one output stage sound processing unit connected to each of the at least one output terminal; and
transmitting an audio signal outputted from the each of the at least one output stage sound processing unit to each of at least one final sound output device through at least one output unit connected to each of the at least one output stage sound processing unit.

15. The method for speaker management of claim 14, wherein the processing at least one fourth audio signal outputted from the at least one output terminal based on a fourth input inputted using the user input unit through at least one output stage sound processing unit connected to each of the at least one output terminal comprises:
performing, through the each of the at least one output stage sound processing unit, at least one of a function of adjusting a volume of the fourth audio signal based on the fourth input, a function of adjusting phase of the fourth audio signal based on the fourth input, a function of adjusting delay of the fourth audio signal based on the fourth input, a function of correcting response characteristic for each frequency band of the fourth audio signal based on the fourth input, and a function of limiting specific frequency band of the fourth audio signal based on the fourth input.

16. The method for speaker management of claim 14, wherein a first frequency response of a first sound outputted from each of the at least one final sound output device corresponds to a second frequency response of a second sound outputted when the first audio signal related to the first input is inputted to a specific sound output device.

17. The method for speaker management of claim 10, wherein the plurality of impulse response filters includes a finite impulse response filter or an infinite impulse response filter.

18. The method for speaker management of claim 10, wherein an outputting a second audio signal obtained by applying a first impulse response filter related to the first input among a plurality of impulse response filters stored in the storage unit to the first audio signal through an impulse response filter application unit comprises:
recognizing the first impulse response filter from the plurality of impulse response filters stored in the storage unit based on the first information and the second information.
